(19) United States
(12) Patent Application Publication
(10) Pub. No.: US 2003/0137073 A1
(43) Pub. Date: Jul. 24, 2003

(54) Injection molding machine, and method of injection molding an electrode plate from plastic material containing graphite or the like

(75) Inventor: Dietrich Hunold, Munchen (DE)

Correspondence Address: HENRY M FEIEREISEN, 350 FIFTH AVENUE, SUITE 3220, NEW YORK, NY, 10118, US

(73) Assignee: KRAUSS-MAFFEI KUNSTSTOFFTECHNIK GMBH, Munchen (DE)

(21) Appl. No.: 10/307,826

(22) Filed: Dec. 2, 2002

(30) Foreign Application Priority Data
Dec. 1, 2001 (DE) 101 59 116.0-45

(51) Int. Cl. B29C 45/00; B29C 71/02

(52) U.S. Cl. 264/104; 264/105; 264/328.18; 264/162; 264/234; 264/235; 425/587

(57) ABSTRACT

In a method of making an electrically conductive electrode member, a compound material, containing a binder made of polymer plastic and 80 weight % of a powdery electrically conductive material as filler, is introduced into a plasticizing screw of an injection molding machine for transforming the compound material to a plasticized material and discharging the plasticized material via a nozzle having a length of less than 15 mm for subsequent injection molding. The injection molding machine is constructed throughout a material flow passage from a point of introduction of the compound material to the injection mold to have only tapered portions which narrow a flow cross section by not more than 10:1.

### CROSS-REFERENCES TO RELATED APPLICATIONS

This application claims the priority of German Patent Application, Serial No. 101 59 116.0-45, filed Dec. 1, 2001, pursuant to 35 U.S.C. 119(a)-(d), the disclosure of which is incorporated herein by reference.

### BACKGROUND OF THE INVENTION

The present invention relates to an injection molding machine, and a method of injection molding an electrode plate from plastic material containing graphite or the like material to impart a high electric conductivity.

Some technical applications demand the use of electrodes with high electrical conductivity as well as good resistance against aggressive fluids. Fuel cells represent here a particularly relevant field which uses plate-shaped or membrane-shaped electrodes, also called bipolar plates, for current conduction and, in addition, for supply and discharge in a finely distributed manner of liquid and gaseous components, which participate in the reaction in the fuel cell. As a result of this function, bipolar plates have a complex contour with plural small flow channels.

German Pat. No. DE 43 14 745 C1 and U.S. Pat. No. 5,733,678 describe electrode plates for fuel cells. The electrode plates are made of plastic material containing a fraction of conductive powder such as coal or graphite. International publication no. WO 00/30202 describes an injection molding method of fabricating electrode plates for fuel cells by compounding, extruding and pelletizing a mixture of polymer plastic and graphite powder to obtain a starting material from which the electrode plates are injection molded.

For convenience and sake of simplicity, the following description refers only to graphite or graphite powder as additive to the plastic material. It is to be understood, however, that the principles described in the following description with respect to graphite are generally applicable to other like material, such as coal or coke.

Injection-molding of electrode plate made of plastic material containing graphite poses problems, when the fraction of graphite powder is high, e.g. more than 80% by weight. Such a high fraction of graphite powder is desirous because of the good conductivity of the fuel cell and the good efficiency of the fuel cell. Compound material containing a high portion of graphite powder is difficult to mold because as a consequence of its mushy consistence and its very high viscosity, the compound material does not flow freely and tends to form bridges at cross sectional restrictions of the processing unit.

It would therefore be desirable and advantageous to provide an improved injection molding machine and method of injection molding an electrode plate from plastic material containing graphite, to obviate prior art shortcomings.

### SUMMARY OF THE INVENTION

According to one aspect of the present invention, a method of making an electrically conductive electrode member, in particular bipolar plates for fuel cells, includes the steps of preparing a compound material including a binder made of polymer plastic and 80 weight % of a powdery electrically conductive material as filler, introducing the compound material into a plasticizing screw of an injection molding machine for transforming the compound material to a plasticized material and discharging the plasticized material via a nozzle having a length of less than 15 mm, injection molding the plasticized material in an injection mold of the injection molding machine, whereby the injection molding machine is constructed throughout a material flow passage from a point of introduction of the compound material to the injection mold to have only tapered portions which narrow a flow cross section by not more than 10:1.

According to another feature of the present invention, the tapered portions narrow a flow cross section in the injection molding machine by not more than 5:1.

According to another feature of the present invention, the powdery electrically conductive material is graphite, coke or coal.

According to another feature of the present invention, the compound material may be forced into the plasticizing screw by a charging device including a rotatable feed hopper and conveyor screw extending through the feed hopper. The compression-less conveyor screw has a great depth of thread, suitably a depth of thread of at least one quarter of the screw diameter.

According to another feature of the present invention, the compound material is introduced in controlled doses into the plasticizing screw in such a way that the plasticizing screw is filled by not more than 90%, preferably by not more than 80%. Thus, the plasticizing screw is not fully charged by the metered introduction of the material through use of a suitable metering device, e.g. a conveyor-type weigher.

As the graphite content is high in the compound material being processed, the compression ratio of the plasticizing screw should be kept small. When thermoplastic material is involved, the compression ratio of the plasticizing screw should not be more than 1.6:1, whereas in the event duroplastic material is involved, the compression ratio of the plasticizing screw should not be more than 1:1.2.

Suitably, the plasticizing screw should also have an increased depth of thread. According to another feature of the present invention, the plasticizing screw has a screw diameter and a depth of thread of at least one eighth of the screw diameter. Currently preferred is a depth of thread which is at least one quarter of the screw diameter.

According to another feature of the present invention, the plasticizing screw may have a pressure-applying flank at a negative angle to enhance the particular flow properties of graphite. Suitably, the plasticizing screw may have a pitch between 0.5 and 1.

In order to prevent excessive back flow of the compound material in the plasticizing screw, the use of a back flow valve may be contemplated which should have an extremely great flow cross section for the particular material properties involved. As an alternative, plasticizing and injection operations may be separated through provision of interposed valves, whereby the injection is realized via an injection plunger (shot sleeve).

Shaping of the electrode plates may be realized through injection molding or an injection compression process.

According to another feature of the present invention, there is provided a further step of mechanically treating a surface layer of the finished electrode member, e.g. through sand blasting. This is desirous because of the tendency of injection-molded articles of plastic with high graphite content to form on the surface a graphite-deficient layer. This impairs the conductivity of the electrode plates. Through sand blasting, the surface layer is removed and the conductivity is enhanced. In addition, it may be suitably to subject the produced electrode member to a subsequent temperature treatment, such as tempering, annealing or sintering, to further enhance the properties of the injection-molded products.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic, partly sectional view of an injection molding machine, embodying the subject matter of the present invention;

FIG. 2 is an enlarged detailed view of a leading portion of a plasticizing cylinder of the injection molding machine FIG. 1;

FIGS. 3a to 3c show schematic illustrations of exemplified cross sectional tapers of the plasticizing barrel;

FIG. 4 is a cutaway sectional view of a plasticizing screw according to the present invention; and

FIG. 5 is a cutaway sectional view of a modified plasticizing screw according to the present invention.

### DETAILED DESCRIPTION OF PREFERRED EMBODIMENTS

The present invention is directed to a method of making conductive, plate-shaped electrode, in particular bipolar plates, for fuel cells, through injection molding a compound material made of a thermoplastic or duroplastic material as binder, and a conductive powder, in particular graphite, coke or the like as filler. Throughout all the Figures, same or corresponding elements are generally indicated by same reference numerals. These depicted embodiments are to be understood as illustrative of the invention and not as limiting in any way.

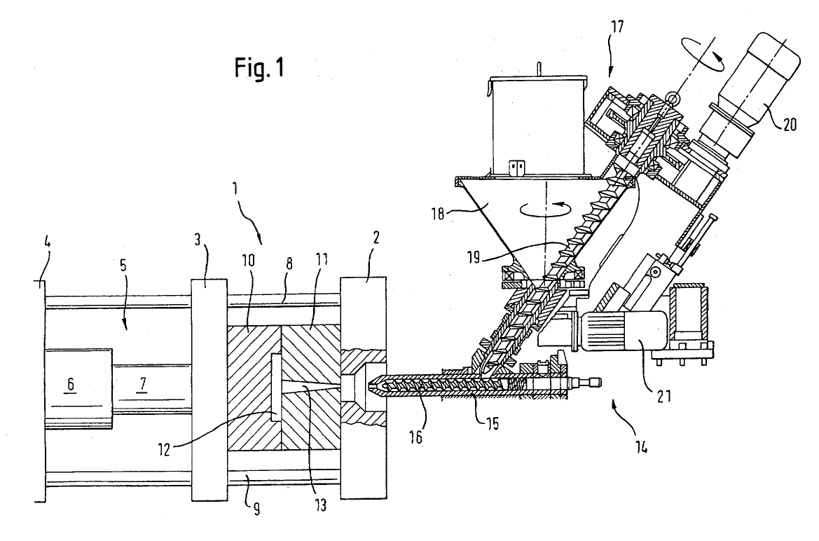

Turning now to the drawing, and in particular to FIG. 1, there is shown a schematic, partly sectional view of an injection molding machine, embodying the subject matter of the present invention. The injection molding machine includes a three-platen closing unit, generally designated by reference numeral 1 and including a fixed mold mounting plate 2 for carrying a half-mold 11, a moveable mold mounting plate for carrying a half-mold 10, and a support plate 4. A drive 5, e.g., a hydraulic drive with cylinder 6 and reciprocating piston 7, moves the mold mounting plate 3 to and away relative to the fixed mold mounting plate 2. The moveable mold mounting plate 3 is guided along four tie bars 8 (only two are visible in FIG. 1) which extend between the support plate 4 and the fixed mold mounting plate 2. When the half-molds 10, 11 are closed, a cavity 12 is demarcated for molding compound material introduced through a conical sprue channel 13 by an injection unit, generally designated by reference numeral 14.

The injection unit 14 includes a plasticizing barrel 15 which accommodates a rotatable plasticizing screw 16 for axial displacement therein. Supply of compound material into the plasticizing barrel 15 is implemented by a charging device, generally designated by reference numeral 17 and including a feed hopper 18, which is driven by a drive motor 21 for rotation in a direction indicated by the arrow, and a conveyor screw 19, which extends through the hopper 18 and is driven by a drive motor 20. A specific construction and manner of a charging device of this type is fully described in U.S. Pat. No. 5,577,839 and German Pat. No. DE 37 12 828 C2, the entire specification and drawings of which are expressly incorporated herein by reference.

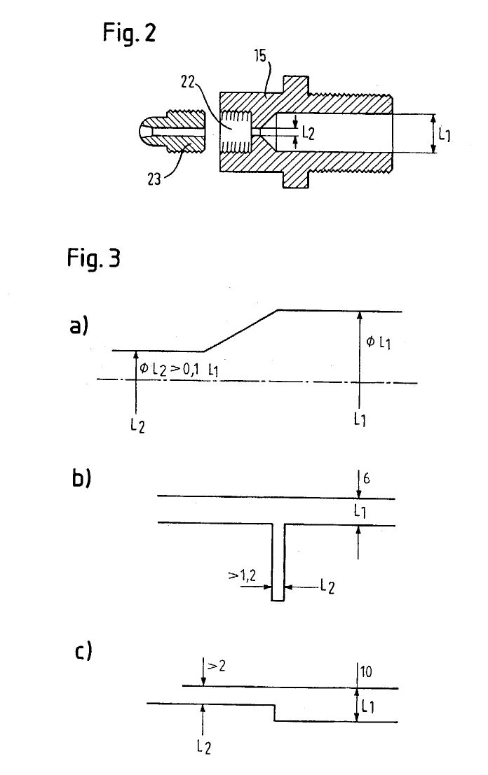

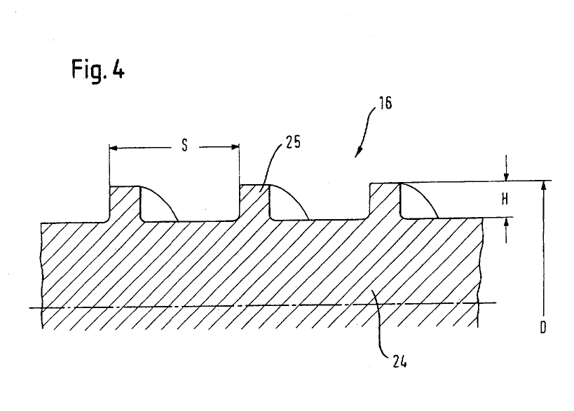

Turning now to FIG. 2, there is shown an enlarged detailed view of a leading portion of the plasticizing barrel 15 of the injection molding machine. At its forwardmost end, the plasticizing barrel 15 has a recess 22 for accommodation of a nozzle 23 having a length of less than 15 mm. The plasticizing barrel 15 has a flow cross section L₁ which tapers towards a channel 9, defined by a flow cross section L₂, for communication to a fluid passageway within the nozzle 23. Throughout its flow passage, the plasticizing barrel 15 is so configured that each cross sectional restriction does not decrease the cross section by more than 10:1, preferably not more than 5:1. According to FIG. 2, the ratio of L₁ to L₂ is smaller than 10, preferably smaller than 5. Also the transition from the changing device 17 into the plasticizing barrel 15 should have a cross sectional restriction of corresponding configuration. FIG. 3 show various examples of cross sectional restrictions of the plasticizing barrel 15, whereby L₁ refers to the greater cross section and L₂ refers to the smaller (tapered) cross section. It will be understood by persons skilled in the art that the terms “restriction” and “taper” are used synonymous in the disclosure. The afore-stated numerical data represent relative values and may be given in centimeters or millimeters.

FIG. 4 is a cutaway sectional view of the plasticizing screw 16 which includes a base body 24 and screw lands 25. The pitch between screw lands 25 in axial direction of the plasticizing screw 16 is designated by reference character S, whereas the height of the screw land 25 above the base body 24 is designated by reference character H and represents the depth of thread. The diameter of the plasticizing screw 16 is designated by reference character D. Suitably, the depth of thread H is at least one eight, preferably one quarter of the screw diameter D, i.e. H:D>0.125 to 0.25. Furthermore, the pitch S should be between 0.5 and 1, i.e. 0.5≦S/D≦1.

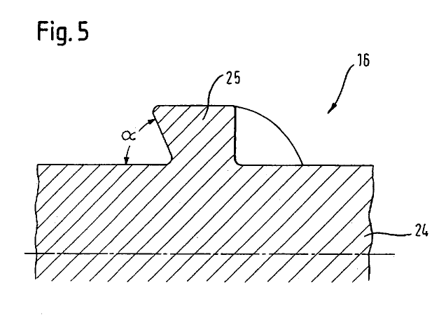

FIG. 5 is a cutaway sectional view of a modified plasticizing screw 16 with a negative angle a of the pressure-applying flank of the screw land 25, i.e. α<90°.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method of making an electrically conductive electrode member in particular bipolar plates for fuel cells, comprising the steps of:
preparing a compound material including a binder made of polymer plastic and 80 weight % of a powdery electrically conductive material as filler;
introducing the compound material into a plasticizing screw of an injection molding machine for transforming the compound material to a plasticized material and discharging the plasticized material via a nozzle having a length of less than 15 mm;
injection molding the plasticized material in an injection mold of the injection molding machine,
whereby the injection molding machine is constructed throughout a material flow passage from a point of introduction of the compound material to the injection mold to have only tapered portions which narrow a flow cross section by not more than 10:1.

2. The method of claim 1, wherein the tapered portions narrow a flow cross section in the injection molding machine by not more than 5:1.

3. The method of claim 1, wherein the powdery electrically conductive material is graphite or coal.

4. The method of claim 1, wherein the compound material is forced into the plasticizing screw by a charging device including a rotatable feed hopper and a conveyor screw extending through the feed hopper.

5. The method of claim 1, wherein the compression ratio in the plasticizing screw is not more than 1.6:1.

6. The method of claim 1, wherein the binder is made of duroplastic material, wherein the compression ratio in the plasticizing screw is not more than 1:1.2.

7. The method of claim 1, wherein the compound material is introduced in controlled doses in a way that the plasticizing screw is filled by not more than 90%.

8. The method of claim 1, wherein the plasticizing screw is filled with the compound material by not more than 80%.

9. The method of claim 1, wherein the plasticizing screw has a screw diameter and a depth of thread of at least one eighth of the screw diameter.

10. The method of claim 1, wherein the plasticizing screw has a screw diameter and a depth of thread of at least one quarter of the screw diameter.

11. The method of claim 1, wherein the plasticizing screw has a pressure-applying flank at a negative angle.

12. The method of claim 1, wherein the plasticizing screw has a pitch between 0.5 and 1.

13. The method of claim 1, wherein the injection molding step in the injection mold involves an injection compression process for making an electrode member.

14. The method of claim 1, and further comprising the step of mechanically treating a surface layer of the electrode member.

15. The method of claim 14, wherein the mechanically treating step includes sand blasting.

16. The method of claim 1, and further comprising the step of subjecting the produced electrode member to a subsequent temperature treatment.

17. The method of claim 16, wherein the temperature treatment is a process selected from the group consisting of tempering, annealing and sintering.

18. An injection molding machine for making an electrically conductive electrode member, comprising:
a charging device for providing a compound material, containing polymer plastic and 80 weight % of a powdery electrically conductive material;
a plasticizing screw for transforming the compound to a plasticized material and discharging the plasticized material via a nozzle of a length of less than 15 mm in an injection mold of the injection molding machine;
an injection mold receiving the plasticized material from the plasticizing screw,
wherein the injection molding machine is constructed throughout a material flow passage from a point of introduction of the compound material to the injection mold to have only tapered portions which narrow a flow cross section by not more than 10:1.

19. The injection molding machine of claim 18, wherein the tapered portions narrow a flow cross section by not more than 5:1.

20. The injection molding machine of claim 18, wherein the compression ratio in the plasticizing screw is not more than 1.6:1.

21. The injection molding machine of claim 18, wherein the compression ratio in the plasticizing screw is not more than 1:1.2.

22. The injection molding machine of claim 18, wherein the charging device introduced the compound material in controlled doses in a way that the plasticizing screw is filled by not more than 90%.

23. The injection molding machine of claim 22, wherein the plasticizing screw is filled with the compound material by not more than 80%.

24. The injection molding machine of claim 18, wherein the plasticizing screw has a screw diameter and a depth of thread of at least one eighth of the screw diameter.

25. The injection molding machine of claim 18, wherein the plasticizing screw has a screw diameter and a depth of thread of at least one quarter of the screw diameter.

26. The injection molding machine of claim 18, wherein the plasticizing screw has a pressure-applying flank at a negative angle of less than 90°.

27. The injection molding machine of claim 18, wherein the plasticizing screw has a pitch between 0.5 and 1.
